(19) United States
(12) Patent Application Publication
(10) Pub. No.: US 2002/0164400 A1
(43) Pub. Date: Nov. 7, 2002

(54) Method for minimizing beta glucan problems in beer brewing

(76) Inventor: Kenneth A. Berg, North Wales, PA (US)

Correspondence Address: Christopher R. Lewis, RATNER & PRESTIA, One Westlakes, Berwyn, Suite 301, P.O. Box 980, Valley Forge, PA, 19482-0980, US

(21) Appl. No.: 09/800,020

(22) Filed: Mar. 5, 2001

(51) Int. Cl. C12C 11/00

(52) U.S. Cl. 426/16

(57) ABSTRACT

A method of producing wort or beer which avoids or minimizes problems encountered with high beta glucan content such as slow lautering of wort, slow filtration of beer, decreased yields, gel precipitations in the package, unfilterable beer haze, and colloidal instability. This method involves modifying the malt to an extent which reduces the beta glucan content to a sufficiently low value such that these problems are avoided or minimized sufficiently. An undesirable side effect of malting to this extent is that certain undesirable constituents, such as color components (causing the beer to be dark) and certain proteins, are formed. An adsorbent is contacted with the wort or beer to remove these undesirable constituents from the wort or beer. The adsorption step preferably utilizes clay, such as montmorillonite or bentonite, that can be readily filtered.

### TECHNICAL FIELD

This invention relates generally to beer brewing and, more specifically, to avoiding or minimizing problems associated with high beta glucan content in beer.

### BACKGROUND OF THE INVENTION

The process of brewing beer involves a number of well known steps including: malting a carbohydrate and protein source (such as barley); milling the malted barley; mashing to convert starches to sugars and to recover a sugar-enriched wort; brewing the wort by boiling and adding hops; cooling and aerating the wort; fermenting the wort by adding yeast to form alcohol, carbon dioxide, and other constituents; and then maturing, filtering, and carbonating the beer. The selection of the barley or other carbohydrate and protein source as well as the malting process has a significant effect on the chemical composition of the malted barley. One of the constituents of malted barley are beta glucans. Beta glucans are a family of polysaccharides made up of unbranched chains of beta-D-glucopyranose residues joined by (1→4) and (1→3) linkages. Beta glucans are the primary constituent of endosperm cell walls of barley.

Beer brewing suffers from occasional and regular production and quality losses due to beta glucans and beta glucan gels in the wort and beer. These problems include slow lautering of wort, slow filtration of beer, decreased yields, gel precipitations in the package, unfilterable beer haze (including pseudo or invisible haze), and colloidal instability.

Several solutions to high beta glucan content have been utilized. One is to initially select barley that is low in beta glucan content. This sometimes is impossible, however, since a drought can make all available barley for that year high in beta glucans. A second solution is to malt in such a way which fully modifies the barley, as described below. Although this has the effect of reducing the beta glucan content, this procedure produces a beer with too dark of a color for many pale beer formulas and results in the formation of other proteins which are undesirable. As discussed herein, the color components responsible for causing this dark color and the other undesirable proteins are referred to as “undesirable constituents” produced when a barley is fully modified.

Another solution for reducing the beta glucan content involves adjusting the mashing procedure to increase the activity of naturally occurring beta glucanase without overstimulating beta glucan solubilase. Beta glucanase is an enzyme which breaks down beta glucans, while beta glucan solubilase is an enzyme that releases beta glucan from the malt. Decreased mash aeration, thicker mashes, coarser malt milling, and gentler stirring can all decrease beta glucan in the finished wort. All of these methods can decrease production efficiency or rate. Addition of beta glucanase to the mash is also an option, but adds cost, complexity, and is not always effective.

### SUMMARY OF THE INVENTION

The present invention provides a method for producing a wort or a beer with minimal beta glucan problems in beer brewing, even though the barley used may be high in beta glucans. The invention involves the steps of (1) effecting changes to the malting process to produce a modified malt having a beta glucan content sufficiently low such that no further reduction in beta glucan content is needed and (2) contacting an adsorbent with either the wort or the beer produced from the wort to remove certain undesirable constituents which are produced during the revised malting process.

In particular, according to a first embodiment of the present invention directed to producing a wort, a carbohydrate and protein source is malted under conditions sufficient to produce a modified malt having a beta glucan content below a value at which no further reduction in beta glucan content is needed. As a consequence of malting to this extent, certain undesirable constituents are produced during the malting step. The modified malt is then mashed to produce a mash having solids which are then separated from the mash to produce a wort, which is in a liquid form. Then, an adsorbent, such as clay, and preferably montmorillonite, is contacted with the wort to remove the undesirable constituents. Subsequently, the adsorbent is removed from the wort.

According to another embodiment of the present invention, a method for producing a beer involves the same malting, mashing, and separating steps as in the embodiment discussed above. After the wort is produced according to this embodiment, it is fermented to produce a beer. Then, the beer is contacted with an adsorbent of the present invention to remove the undesirable constituents produced during the malting step. Subsequently, the adsorbent is removed from the beer.

The present invention may also be viewed as a method of using an adsorbent involving the steps of providing a wort produced from a modified malt having a beta glucan content below a value at which no further reduction in beta glucan content is needed, with the malting process resulting in the formation of undesirable constituents. According to this embodiment, the adsorbent is then contacted with the wort to remove the undesirable constituents and the adsorbent is removed from the wort.

Analogous to the second embodiment of the invention, a method of using an adsorbent according to the invention could also involve providing a beer produced from a wort which, in turn, is produced from the modified malt having a beta glucan content below a value at which no further reduction in beta glucan content is needed, with the modified malt also including undesirable constituents as discussed above. According to this embodiment invention, an adsorbent is contacted with the beer to remove the undesirable constituents and, subsequently, the adsorbent is removed from the beer.

It is to be understood that both the foregoing general description and the following detailed description are exemplary but not restrictive, of the invention.

### BRIEF DESCRIPTION OF THE DRAWINGS

FIG. 1 is a graphical depiction of the color in degrees by American Society of Brewing Chemists (ASBC) of a beer based on varying dosages of Tansul-7 clay.

FIG. 2 is a graphical depiction of protein measured by Total Kjeldhahl Nitrogen (TKN) in beer based on varying dosages of Tansul-7 clay.

FIG. 3 is a graphical depiction of protein measured by TKN in beer based on varying dosages of carbon.

FIG. 4 is a graphical depiction of soluble protein of wort measured by TNK (in mg/L) based on varying dosages of Tansul-7 clay.

FIG. 5 is a graphical depiction of the color rating in degrees based on varying dosages of Tansul-7 clay after two days have elapsed from wort production.

FIG. 6. is a graphical depiction of the color rating in degrees based on varying dosages of Tansul-7 clay after four days have elapsed from wort production.

### DETAILED DESCRIPTION OF THE INVENTION

The present invention allows for the avoidance or minimization of the problems associated with high beta glucan content in wort or beer. The present invention achieves this goal by making two primary changes to a conventional beer brewing process. First, the malting step is carried out to such an extent that the beta glucan content in the modified malt is reduced such that no further reduction is required. Second, an adsorbent is contacted with the wort or the beer to remove certain undesirable constituents formed during the malting process, such as color components responsible for causing the wort or beer made from the modified malt to be dark, among others. Thus, the present invention permits the use of a malt modified according to the present invention for producing pale beers, without encountering the problems associated with high beta glucan content.

The starting material for the methods of producing a wort or beer according to the present invention is a carbohydrate and protein source. Any such source known to be used as a starting material in beer brewing which might lead to undesirably high beta glucan content is suitable for use with the present invention. The most common starting material for beer brewing is barley, although other cereal grains, such as wheat, rice, corn, oats, and rye, may alternatively or additionally be used.

After selecting a suitable starting material, the material is malted as is well known in the art. The malting process converts insoluble starch to soluble starch, reduces complex proteins, and generates nutrients for yeast development. The first step of malting is steeping, which involves mixing the barley kernels with water and s allowing the mixture to soak for a long period of time, such as 40 hours. Steeping allows moistening of the kernels and activates the metabolic process of the kernel. Steeping is complete when white tips of rootlets emerge, which is known as chitting. Next, the wet barley is germinated by maintaining it at a suitable temperature and humidity, until adequate modification has been achieved, as discussed below. Modification refers to the extent to which endosperm of wet barley breaks down. During this malting process, enzymes break down the complex starches and proteins of the grain. The enzymes also aid in breaking down beta glucans.

More specifically, as is well known in the art, at a higher temperature or a higher humidity (or both) during the germination step, the beta glucan content in the malt decreases. According to the present invention, the conditions of malting, primarily the temperature and humidity of germination and the temperature of kilning (discussed below), are selected to produce a modified malt having a beta glucan content below a value at which no further reduction in beta glucan content is needed. This value can be determined based on a number of factors, such as the desired lautering rate of the wort, the desired filtration of the beer, the desired yield, the acceptable level of precipitation in the package, the acceptable level of beer haze, and the acceptable level of colloidal instability. This will vary, of course, with the grade of beer being produced and the processing conditions and systems used to produce the beer. In addition, the conditions necessary to brew the modified malt having a beta glucan content below a certain value will also depend upon the carbohydrate and protein source being selected. For example, different types of barley can lead to malt having different amounts of beta glucan therein even under the same conditions. In addition, barleys vary from year to year with the amount of rainfall and other growing conditions. In particular, as mentioned above, a drought can make all available barley for that year high in beta glucans.

Accordingly, although the desired value of beta glucan content in the malt varies significantly, it has been found that for many brewers and many beers produced that the beta glucan content in the malt should be less than 4% and preferably less than 1%. Another way of measuring beta glucan content commonly accepted in the art is a viscosity standard of wort. A higher viscosity represents a higher beta glucan content. Accordingly, although this may again vary from beer to beer and the desired quality, a 70° wort viscosity of below 1.7 cp and preferably below 0.1 cp will be suitable for many beers. As is well known in the art, as the temperature and humidity of germination and temperature of kilning are increased to further modify the malt, other constituents are produced. As used herein, some of these other constituents shall be deemed “undesirable constituents” in that they are not desirable for the particular beer being produced. For example, under these extensive malting conditions, certain color components causing the malt (and the beer produced therefrom) to be dark are undesirable when a pale (or other lighter) beer is sought to be produced. Other undesirable constituents produced during the malting process might include proteins, which tend to form chill haze and certain enzymes.

After germination, the malt is dried in a kiln. The temperature selected for kilning also has an effect on the color of the final malt and the amount of enzymes, which survive for use in mashing process. Thus, the temperature and other conditions during malt kilning, along with the temperature and humidity during germination, are conditions which can be varied in a known way to produce a modified malt having a beta glucan content below a value at which no further reduction in beta glucan content is needed.

Following malting, the dried malt is then typically ground in a mill such that the husk of the grain is in tact while the rest becomes a coarse powder. After milling, various methods of mashing known in the art are used to obtain a wort, which is an aqueous extract of the malt. Mashing involves heating the malt in a vessel to convert starches and any adjuncts (if added) into sugars. A wide variety of mashing techniques are well known in the art and the particular mashing technique is not critical to the present invention. Also, it is not necessary to add beta glucanase which reduces beta glucan content during the mashing step. Mashing typically involves mixing hot water to the ground malt. Then, the wort is separated from the solids of the mash and subsequently cooled.

According to a method for producing a wort of the present invention, after the wort is separated from the solids, an adsorbent is contacted with the wort to remove the undesirable constituents formed during malting. Any adsorbent suitable for removing these constituents may be used. As used herein, when referring to “removing” either the constituents from the wort or the adsorbent from the wort or beer, it is not necessary to remove one hundred percent of such constituents or adsorbents. Instead, only a sufficient extent of the constituents or adsorbent need be removed as desired based on the quality of beer, grade of beer, and other processing conditions, as mentioned above. Preferably, the adsorbent selected does not adsorb other desirable proteins, such as foam-forming proteins, from the wort or beer and does not leach any constituents from the adsorbent to the wort or beer which could adversely affect color or flavor of the beer. Even more preferably, the adsorbent is easily filtered and is compatible with food.

It has been found that certain clays are suitable for use as adsorbents in connection with the present invention. Clay is a generally crystalline, hydrated silicate of aluminum, iron, and magnesium formed by the weathering of rocks. One type of clay which appears to be particularly desirable in connection with the present invention is montmorillonite, which is a type of clay whose composition is approximately Al₂O₃·4SiO₂·H₂O. Montmorillonite is one of the major constituents of bentonite, such as sodium bentonite or calcium bentonite, either of which may be used in connection with the present invention. One commercially available montmorillonite is Tansul-7 clay, sold by NL Baroid Inc. Tansul-7 clay is a beneficiated magnesium montmorillonite. The step of contacting the adsorbent with the wort may be done by forming a slurry at a constant temperature.

The amount of adsorbent used will vary depending on the desired color and type of beer being produced as well as the desired quality of the beer to be produced. One way of measuring the content of adsorbent to be added is to determine the color of the wort before the adsorbent is contacted therewith then identify the desired reduction in color components which would correspond to a reduction in color using a particular test, such as a ASBC Wort 9, spectrophotometer method, published by the American Society of Brewing Chemists, St. Paul, Minn. Depending on the particular beer brewed and its color specification, the reduction in color of the wort should be at least 20 percent, and preferably 30 percent. Another way of determining how much adsorbent should be added is to measure the total protein (TKN) of the wort, with the dose used based on the amount needed to reduce the TKN to the required level. In the case of Tansul-7 clay, the amount of adsorbent added may be in the range of 100 to 2400 ppm, and preferably between 600 and 1200 ppm. As discussed above, these numbers can vary significantly, depending on the amount of color components in the wort as well as the amount desired to be removed.

The actual step of contacting the adsorbent with the wort can be any known adsorption method. For example, the contacting may be done by simply adding some of the adsorbent as a dry powder to the wort and stirring to keep the agent suspended. The adsorbent can also be presuspended in water and added to the wort as a water slurry. Alternatively, the wort may be passed through a bed of granular adsorbent. After the wort is contacted with the adsorbent to reduce the level of undesirable constituents to a desired level, the adsorbent is removed from the wort. This is accomplished by any known separation technique, such as filtering or centrifugation.

According to a second embodiment of the present invention, a method for producing a beer involves the same malting, mashing, and separating steps as discussed above. In the next step, the wort is fermented in a known way to produce a beer. Fermenting involves mixing yeast with the wort to form alcohol, carbon dioxide, and flavors in a known manner.

Following fermentation and the production of a beer, the adsorbent may then be contacted with the beer to remove certain undesirable constituents. Although not necessary, it is preferable that this contacting step is done before the final filtering and carbonation steps to avoid any additional filtering step. It does not appear to be critical whether this is done before or after the beer matures. The manner in which the adsorbent is contacted with the beer may be done in the same way as in connection with the embodiment discussed above in which the adsorbent is contacted with the wort. Preferably, the adsorbent is contacted with the beer by a method that does not introduce any air into the beer.

In selecting the adsorbent, the same considerations should be made as when the adsorbent is selected for removing the undesirable constituents from the wort. It is important to recognize that the beer presents a different environment for the adsorbent than the wort so that a desirable adsorbent for the wort might not necessarily be a desirable adsorbent for the beer. As discussed above, it is preferable to reduce the color rating of the beer to the desired level. In addition, when Tansul-7 clay is used as the adsorbent in the beer, it is typically added in an amount between 100 and 3000 ppm, and preferably between 400 and 1200 ppm.

Following the contacting step, the adsorbent is removed from the beer during a filtering step.

### EXAMPLES

The following examples are representative, not limiting, of the invention.

### Example 1

Tansul-7 clay was identified to have color removal activity towards beer. Color was determined using ASBC Wort 9, spectrophotometer method. Untreated, filtered, high gravity Budweiser®, commercially available from Anheuser-Busch, at 25° C. was used for all experiments. Adsorption was effected by contacting dry powder with 10 ml of beer for ten minutes at 25° C. in a New Brunswick water bath swirling the flasks at 200 rpm. The adsorbents were removed from the beer using centrifugation.

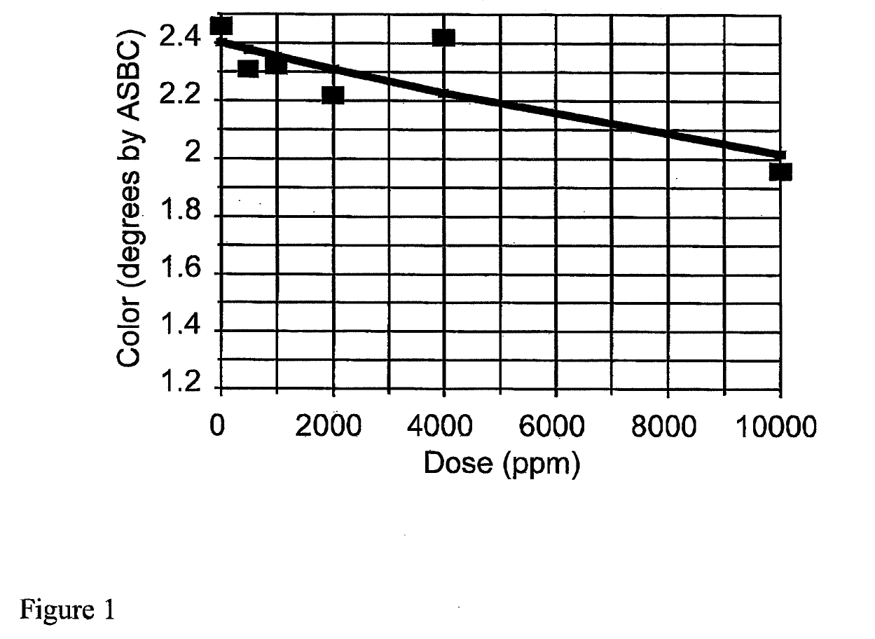

FIG. 1 shows the results of color reduction in the beer using a range of doses between 0 and 10,000 ppm (1% w/v, high gravity basis). A least squares fit to a hyperbolic curve was made to the data and the curve being characterized by a half dose (the dose at which the color is reduced by ½) , maximum color (i.e., untreated) and a minimum color (the color calculated at infinite dose). As shown in FIG. 1, the maximum color untreated was 2.36 degrees, while the minimum color at 10,000 ppm was 1.35 degrees. Extending curve this asymptotically, the minimum color at infinite dose appears to be 1.16 degrees. As can be seen, this Tansul-7 clay appears to give significant color reduction at reasonable does.

### Example 2

This example was done to retest Tansul-7 clay and to test carbon as an adsorbent for removing color components and certain proteins in both beer and wort. Once again, untreated, filtered, high gravity Budweiser® was used for the beer test.

The wort was prepared using ASBC method Malt 4 extract, published by the American Society of Brewing Chemists, St. Paul, Minn. Following the procedure of this test, 50 grams of spray-dried Amber Malt, commercially available from LD Carlson Co. of Kent, Ohio, were weighed equally into four 125-ml Erlenmeyer flasks, each containing 12.5 g of the malt sample. 50 ml of 45° preheated deionized water was added to each malt-containing flask. A glass rod was used to mix the malt sample and water well to prevent the formation of lumps. Upon completion of the mixing, the flasks were placed in a New Brunswick water bath at 45° C. and swirled. The temperature was maintained at 45° C. for thirty minutes, then raised to 70° C. 25 ml of deionized water previously heated to 70-71° was added to each flask and held at 70° C. for sixty minutes. All temperatures specified herein refer to the mash temperature, not the water-bath temperature, unless specified otherwise. After sixty minutes at 70° C., the mash was cooled to room temperature by gradual addition of ice water to the water-bath. The mash was poured into a 500 ml Erlenmeyer flask and adjusted to 450.0 g by addition of deionized water. After filtering the mash into a 500 ml Erlenmeyer flask, the wort was ready for protein and color tests.

Protein was measured as Total Kjeldahl Nitrogen (TKN) following the ASBC method Beer 11, but using Hach Digesdahl Digestion Apparatus to digest samples and Hach DR/4000U Spectrophotometer to determine TKN instead of following the classical Kjeldahl procedures.

For digestion, 1 ml of degassed beer or wort sample was transferred into a 100 ml volumetric flask. The water to the aspirator was turned on and it was ensured that there was suction to the fractionating column. 3 ml of concentrated sulfuric acid was added to the sample in the flask and a weight was immediately placed on the flask followed by a fractionating column with a funnel on the flask. The flask was heated and the temperature dial was set to 440° C. Once the acid started to reflux and/or white acid vapors were present, the sample was allowed to char for five minutes. Then, 10 ml of 50% hydrogen peroxide was added to the sample via the capillary funnel on the fractionating head. The excess hydrogen peroxide was boiled off by heating for two more minutes after all the hydrogen peroxide had drained from the funnel. The flask was then removed from the heater and allowed to cool. Then, the fractionating column was removed from the digestion flask. The digest was diluted to 100 mL with deionized water. The sample was then ready for analysis.

To analyze the wort or beer sample, a Hach DR/4000U Spectrophotometer was used and the program with Total Kjeldahl Nitrogen measurement was selected. 5 ml of the digested samples was pipetted into a 25 ml mixing graduated cylinder and 5 ml of the blank was also added into a separate 25 ml mixing graduated cylinder. One drop of TKN indicator was added to each cylinder then 8.0 N KOH was added dropwise to each cylinder until the first flash blue color appeared, then continued adding 1.0 N KOH dropwise until the first permanent blue color appeared. The cylinders were filled with deionized water to the 20-ml mark. Then, three drops of mineral stabilizer were added to each cylinder. In addition, three drops of polyvinyl alcohol dispersing agent were added to each cylinder. Then, deionized water was added to the cylinder to the 25 ml mark. 1.0 ml of Nesslers Reagent was pipetted to each cylinder and a timer was started to begin a two minute reaction period. At the end of two minutes, the sample was poured into a 25 ml sample cell, with the blank placed in the cell holder to zero the instrument. The prepared sample was then placed in the cell holder and the results appeared in mg/L Total Kjeldahl Nitrogen as N would be displayed.

Color was determined by using the ASBC method Wort 9, spectrophotometer method. Adsorption was carried out by contacting dry powder with 10 ml of beer or wort for ten minutes at 25° C. in a New Brunswick water bath swirling the flasks at 200 rpm. The adsorbents were removed from the beer or wort by centrifugation.

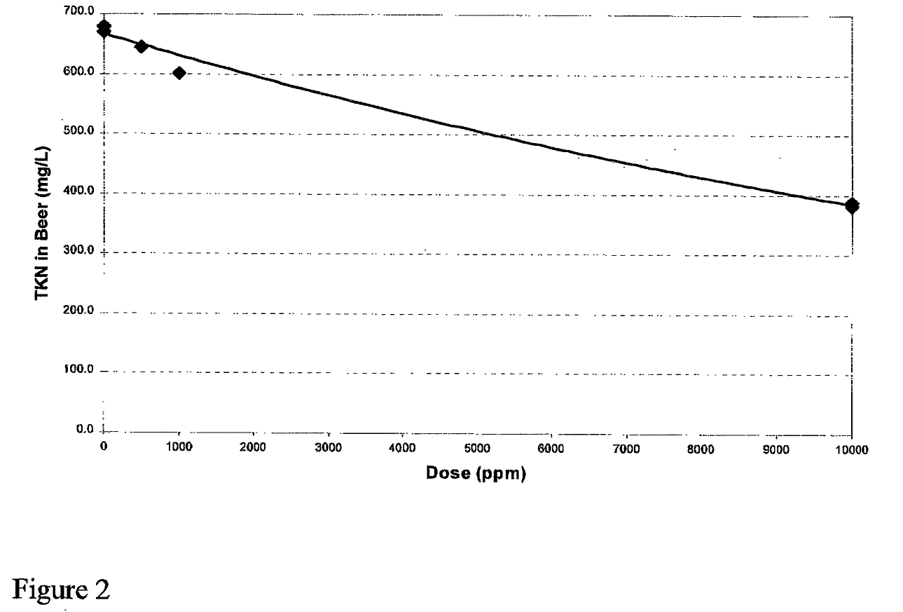

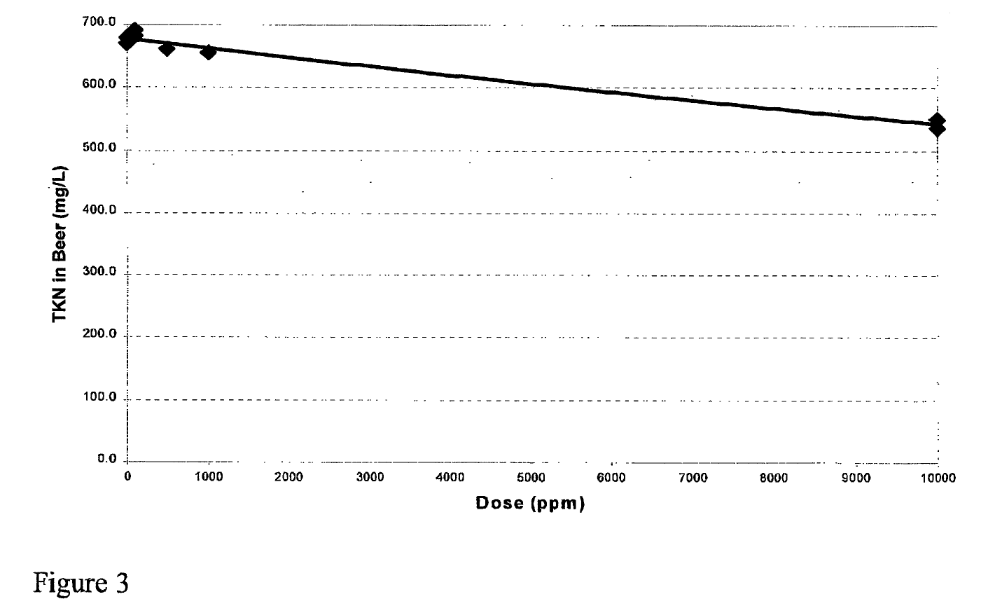

The carbon used was Norit-A, commercially available from Fisher Scientific of Fair Lawn, N.J. The results of beer soluble protein (TKN) for a dose of treatments being 10,000 ppm was 388.2 mg/L for Tansul-7 clay and 549.3 mg/L for carbon, while untreated beer had a value of 679.7 mg/L. FIGS. 2 and 3 shown the TKN dose response using four data points, untreated, 500 ppm, 1000 ppm, and 10,000 ppm for both Tansul-7 clay and carbon, respectively. As can be seen, Tansul-7 clay provides significant reduction of protein at high doses. Carbon can provide some reduction of TKN values at high doses. Wort-soluble protein (using TKN) were measured after treatment with Tansul-7 clay and carbon. Two values were done for both Tansul-7 clay and carbon, with the Tansul-7 clay values being 512.2 and 525.9, and the carbon values being 705.5 and 702.4. These values correspond to an untreated wort soluble protein of 845.2 and 856.2, respectively.

The results of wort color reduction after being treated with Tansul-7 clay and carbon was also done. The color of the two untreated wort samples was 8.0 and 7.8 degrees, with Tansul-7 clay resulting in a final color rating of 5.5 for both data points (31% reduction) and carbon resulting in a 6.4 and 6.3 final color reading, with a percent 5 reduction of 19%.

### Example 3

More testing was done using Tansul-7 clay to determine protein and color reduction in wort. In this example, Malt 942 (a high color and protein, but low beta glucan malt) and Malt 944 (a normal malt), commercially available from ConAgra of Calgary, Canada, was used. Wort was prepared using the ASBC procedure Malt 4, extract, as described above in Example 2. Adsorption was effected in the same way as Example 2 also. In addition, protein was measured and color was determined in the same manner as in Example 2 above.

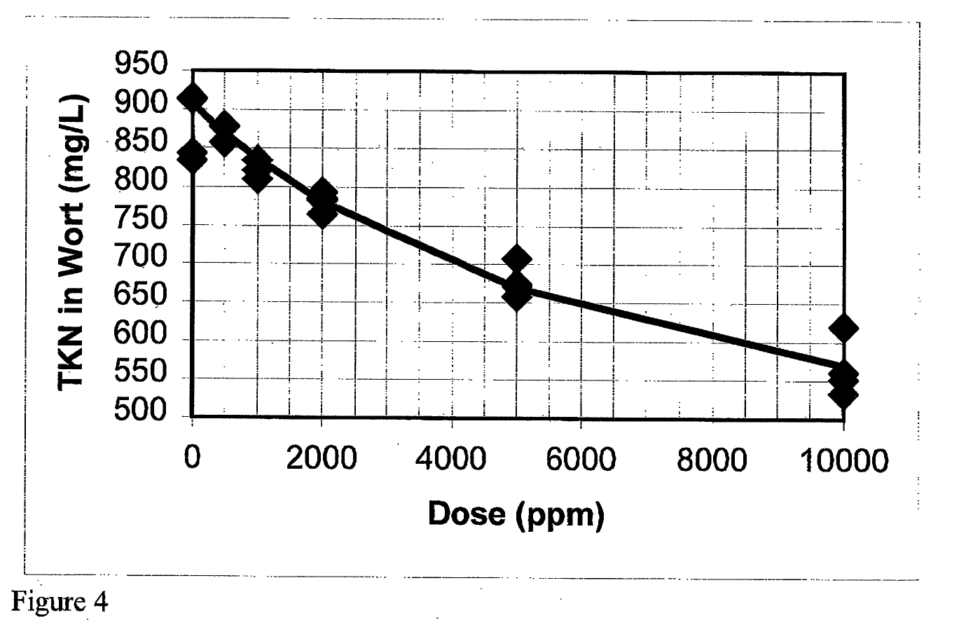

FIG. 4 displays the effect of Tansul-7 clay on soluble protein in wort made from the special malt (i.e., Malt 942). The range of dosages (untreated, 500 ppm, 1000 ppm, 2000 ppm, 5000 ppm, and 10,000 ppm) was tested three times with all the data plotted and the line represents a non-linear fit to a common decay curve. The extra points on the y axis at about 840 mg/L represent the values obtained from the normal malt. Comparison of those values to the fitted line shows that 900 ppm of Tansul-7 clay will reduce the protein from the special malt to normal malt values.

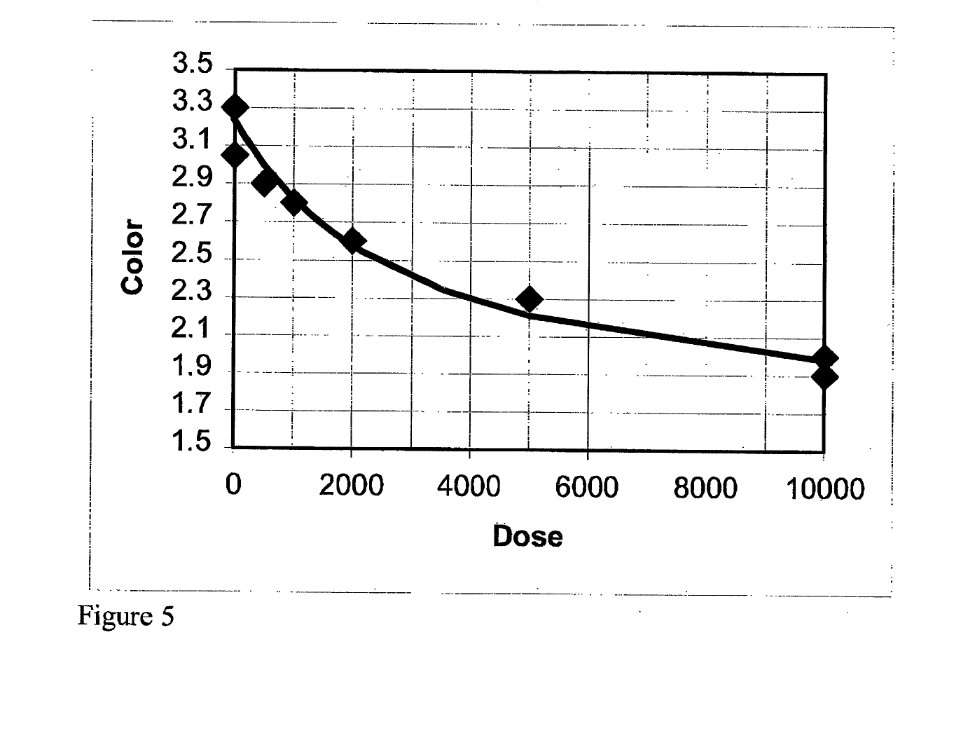

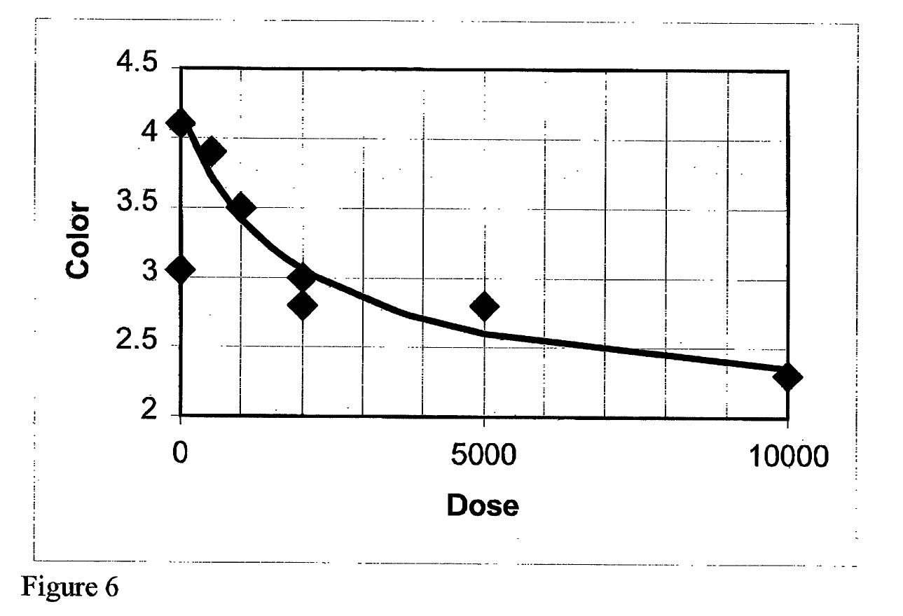

As is well known, the color of wort changes over time even in the cold at 1° C. Accordingly, FIGS. 5 and 6 show a reduction in color when the wort was measured two and four days after production, respectively. Turning to FIG. 5, the solid line is a fit through the whole range of data collected on worts using the special malt. The lower point on the y axis is the color of the control wort from the normal malt. It appears that about 400 ppm of Tansul-7 clay will correct the color under these conditions.

FIG. 6 shows the data from a run identical to that above except the wort was measured four days after production. Under these conditions, about 2100 ppm of the Tansul-7 clay seem to be required to correct the color.

The dose needed to correct color varied from 400 to 2100 ppm, depending on the age of the wort. It is unlikely that a brewery would hold wort before fermentation. The actual dosage necessary under brewery conditions would probably be something in between these two values, but still in the order of magnitude of the dose necessary to remove protein at the same time, perhaps around 1000 ppm.

### Example 4

Testing was done to a variety of clays for both color reduction of a wort and protein as TKN from a wort. The wort was prepared in the same manner as in Example 3 from the special malt. In addition, the malting procedure, adsorption, and other procedures were carried out in the same manner as Example 3.

Table 1 below describes the effect on wort color of a variety of different clays.

TABLE 1

| | Color | | Percent of Goal | |
|---|---|---|---|---|
| Dose: | 1000 ppm | 2000 ppm | 1000 ppm | 2000 ppm |
| Attapulgite | 3.8 | 3.3 | 0 | 18 |
| Bentonite | 3.4 | 2.6 | 61 | 105 |
| Kaolin | 3.8 | 3.3 | 2 | 11 |
| Tansul 7 bentonite | 3.6 | 2.9 | 30 | 69 |

As can be seen from Table 1, only bentonite achieved at least a 100% reduction of the goal (3.1 degrees color) at 2000 ppm, although other clays might be suitable at higher dosages or for different goals or starting points. The color at which no adsorbent is contacted is 3.8 degrees.

Table 2 demonstrates the same solutions as being analyzed for protein as TKN.

TABLE 2

| Agent | TKN Protein | Percent of Goal |
|---|---|---|
| Dose: | 1000 ppm | 1000 ppm |
| Attapulgite | 250 | 33 |
| Bentonite | 44 | 377 |
| Kaolin | 260 | 17 |
| Tansul 7 bentonite | 76 | 323 |

A dose of 1000 ppm is sufficient to remove protein to the goal (210 ppm) for both bentonite and Tansul-7 clay. It appears that more attapulgite and kaolin would be needed to achieve these goals. The TKN protein value for untreated wort was 270.

Although illustrated and described above with reference to certain specific embodiments, the present invention is nevertheless not intended to be limited to the details shown. Rather, various modifications may be made in the details within the scope and range of equivalents of the claims and without departing from the spirit of the invention.

What is claimed is:

1. A method for producing a wort comprising the steps of:
malting a carbohydrate and protein source under conditions sufficient to produce a modified malt having a beta glucan content below a value at which no further reduction in beta glucan content is needed, whereby said modified malt further comprises undesirable constituents produced during said malting;
mashing said modified malt to produce a mash having solids;
separating said solids from said mash to produce a wort;
contacting an adsorbent with said wort to remove said undesirable constituents; and
removing said adsorbent from said wort.

2. The method of claim 1, wherein said undesirable constituents comprise color components and the contacting step comprises adding said adsorbent to said wort in an amount to reduce said color components sufficient to reduce a color rating of said wort by at least 20 %.

3. The method of claim 1, wherein said undesirable constituents comprise color components and the contacting step comprises adding said adsorbent to said wort in an amount to reduce said color components sufficient to reduce a color rating of said wort by at least 30 %.

4. The method of claim 1, wherein said adsorbent comprises clay.

5. The method of claim 4, wherein said clay comprises bentonite.

6. The method of claim 4, wherein said clay comprises montmorillonite.

7. The method of claim 4, wherein said clay comprises beneficiated magnesium montmorillonite.

8. The method of claim 7, wherein the contacting step comprises adding said beneficiated magnesium montmorillonite to said wort in an amount of between 100 and 2400 ppm.

9. The method of claim 7, wherein the contacting step comprises adding said beneficiated magnesium montmorillonite to said wort in an amount of between 600 and 1200 ppm.

10. The method of claim 1, wherein said carbohydrate and protein source comprises barley.

11. The method of claim 1, wherein the step of contacting said adsorbent with said wort comprises mixing said adsorbent with said wort to form a slurry at a constant temperature.

12. The method of claim 1, wherein the step of malting produces a modified malt having a beta glucan content of less than 4%

13. The method of claim 1, wherein the step of malting produces a modified malt having a beta glucan content of less than 1%.

14. A method for producing a beer comprising the steps of:
malting a carbohydrate and protein source under conditions sufficient to produce a modified malt having a beta glucan content below a value at which no further reduction in beta glucan content is needed, whereby said modified malt further comprises undesirable constituents produced during said malting;
mashing said modified malt to produce a mash having solids;
separating said solids from said mash to produce a wort;
fermenting said wort to produce a beer;
contacting an adsorbent with said beer to remove said undesirable constituents; and
removing said adsorbent from said beer.

15. The method of claim 14, wherein said undesirable constituents comprise color components and the contacting step comprises adding said adsorbent to said beer in an amount to reduce said color components sufficient to reduce a color rating of said beer by at least 20%.

16. The method of claim 14, wherein said undesirable constituents comprise color components and the contacting step comprises adding said adsorbent to said beer in an amount to reduce said color components sufficient to reduce a color rating of said beer by at least 30%.

17. The method of claim 14, wherein said adsorbent comprises clay.

18. The method of claim 17, wherein said clay comprises bentonite.

19. The method of claim 17, wherein said clay comprises montmorillonite.

20. The method of claim 17, wherein said clay comprises beneficiated magnesium montmorillonite.

21. The method of claim 20, wherein the contacting step comprises adding said beneficiated magnesium montmorillonite to said beer in an amount of between 100 and 3000 ppm.

22. The method of claim 20, wherein the contacting step comprises adding said beneficiated magnesium montmorillonite to said beer in an amount of between 400 and 1200 ppm.

23. The method of claim 14, wherein said carbohydrate and protein source comprises barley.

24. The method of claim 14, wherein the step of contacting said adsorbent with said beer comprises mixing said adsorbent with said beer to form a slurry at a constant temperature.

25. The method of claim 14, further comprising, after the separating step, the steps of boiling said wort and cooling said wort.

26. The method of claim 25, wherein the fermenting step comprises mixing yeast with said wort to produce said beer.

27. The method of claim 14, wherein the step of malting produces a modified malt having a beta glucan content of less than 4%.

28. The method of claim 14, wherein the step of malting produces a modified malt having a beta glucan content of less than 1%.

29. A method of using an adsorbent comprising the steps of:
providing a wort produced from a modified malt having a beta glucan content below a value at which no further reduction in beta glucan content is needed, whereby said modified malt further comprises undesirable constituents produced during malting;
contacting an adsorbent with said wort to remove said undesirable constituents; and
removing said adsorbent from said wort.

30. The method of claim 29, wherein said adsorbent comprises clay.

31. The method of claim 30, wherein said clay comprises bentonite.

32. The method of claim 30, wherein said clay comprises montmorillonite.

33. The method of claim 30, wherein said clay comprises beneficiated magnesium montmorillonite.

34. A method of using an adsorbent comprising the steps of:
providing a beer produced from a wort, wherein said wort is produced from a modified malt having a beta glucan content below a value at which no further reduction in beta glucan content is needed, whereby said modified malt further comprises undesirable constituents produced during malting;
contacting an adsorbent with said beer to remove said undesirable constituents; and
removing said adsorbent from said beer.

35. The method of claim 34, wherein said adsorbent comprises clay.

36. The method of claim 34, wherein said clay comprises bentonite.

37. The method of claim 34, wherein said clay comprises montmorillonite.

38. The method of claim 34, wherein said clay comprises beneficiated magnesium montmorillonite.
